(19) United States
(12) Patent Application Publication
(10) Pub. No.: US 2019/0344766 A1
(43) Pub. Date: Nov. 14, 2019

(54) Hydraulic Dual Circuit Vehicle Brake System

(71) Applicant: Robert Bosch GmbH, Stuttgart (DE)

(72) Inventors: Edgar Kurz, Heilbronn-Horkheim (DE); Wolfgang Schuller, Cleebronn (DE)

(21) Appl. No.: 16/407,698

(22) Filed: May 9, 2019

(30) Foreign Application Priority Data
May 9, 2018 (DE) 10 2018 207 214.0

(51) Int. Cl. B60T 13/14; B60T 8/40; B60T 8/42; B60T 8/48

(52) U.S. Cl. CPC B60T 13/148; B60T 8/4031; B60T 8/4872; B60T 8/4291; B60T 8/4068

(57) ABSTRACT

A hydraulic dual circuit vehicle brake system includes a slip control member and a piston/cylinder unit between pressure sides of two piston pumps for a more homogeneous brake fluid delivery. The piston of the piston/cylinder unit is clamped in elastically between two elastic and annular displacement bodies.

This application claims priority under 35 U.S.C. § 119 to patent application no. DE 10 2018 207 214.0, filed on May 9, 2018 in Germany, the disclosure of which is incorporated herein by reference in its entirety.

### BACKGROUND

The disclosure relates to a hydraulic dual circuit vehicle brake system.

Laid open specification DE 10 2004 061 811 A1 discloses a hydraulic dual circuit vehicle brake system for a passenger motor car having a dual circuit brake master cylinder, to which two brake circuits with in each case two hydraulic wheel brakes are connected, which brake circuits can be loaded with pressure by way of the brake master cylinder and can be actuated as a result. The wheel brakes are not connected directly to the brake master cylinder, but rather indirectly by way of solenoid valves. Moreover, the known vehicle brake system has a piston pump as hydraulic pump in each brake circuit, which piston pumps can be driven jointly by way of an electric motor. Suction sides of the piston pumps are connected to the wheel brakes (with solenoid valves connected in between), and pressure sides of the piston pumps are likewise connected to the wheel brakes and to the brake master cylinder (likewise with solenoid valves connected in between), with the result that brake fluid is sucked out of the wheel brakes by way of the piston pumps, in order to lower wheel brake pressures in the wheel brakes, and can be conveyed in the direction of the brake master cylinder or back into the wheel brakes in order to increase the wheel brake pressures. Slip control systems such as an anti-lock brake system, a traction control system and/or a vehicle dynamics control system/electronic stability program, for which the abbreviations ABS, ASR and FDR/ESP are customary, are possible in a known way by way of the hydraulic pumps and solenoid valves. A vehicle dynamics control system and electronic stability program are also colloquially called anti-skid control systems.

Piston pumps deliver in a pulsing manner in each case during a work stroke or displacement stroke, whereas delivery is not carried out during a suction stroke or return stroke. The two piston pumps of the known vehicle brake system deliver in opposite directions, that is to say one of the two piston pumps is always delivering while the other piston pump is not delivering. A piston/cylinder unit with a spring-centered piston is arranged hydraulically between the pressure sides of the two piston pumps, one piston side communicating with the pressure side of the one piston pump, and another piston side communicating with the pressure side of the other piston pump, with the result that a complete or partial pressure equalization takes place and a hydraulic disconnection of the two brake circuits is ensured. During the work stroke or displacement stroke of one of the two piston pumps, said piston pump delivers brake fluid into the piston/cylinder unit and displaces the piston of the latter in the cylinder, as a result of which a brake pressure rise in the brake circuit, the piston pump of which is currently delivering, is lower and slower than it would be without the piston/cylinder unit. In the other brake circuit, the piston pump of which is currently not delivering, the delivering piston pump of the one brake circuit generates or increases a brake pressure by way of the piston/cylinder unit. As a result, the delivery of brake fluid by way of the piston pumps is more uniform in the two brake circuits, a brake pressure rise is slowed, and brake pressure peaks and brake pressure pulses are reduced. As a result, a generation of noise is reduced, comfort is increased, controllability is improved, and hydraulic/mechanical loading of the vehicle brake system is reduced.

### SUMMARY

The hydraulic dual circuit vehicle brake system according to the disclosure has a dual circuit brake master cylinder, to which two brake circuits with in each case at least one hydraulic wheel brake are connected, which brake circuits can be loaded with pressure by way of the brake master cylinder and can be actuated as a result. Moreover, there are a hydraulic pump and valves, in particular solenoid valves, in each brake circuit. Suction sides of the hydraulic pumps are connected to the wheel brakes (preferably with valves connected in between), and pressure sides of the hydraulic pumps are likewise connected to the wheel brakes and to the brake master cylinder (likewise preferably with valves connected in between), with the result that, in order to dissipate wheel brake pressure in the wheel brakes, brake fluid can be delivered by way of the hydraulic pumps out of the wheel brakes in the direction of the brake master cylinder and, in order to increase the wheel brake pressures in the wheel brakes, can be delivered into them. By way of the hydraulic pumps, an actuation of the wheel brakes without actuation of the brake master cylinder and an increase of a brake pressure in the case of an actuated brake master cylinder are possible. Furthermore, slip control systems, such as an anti-lock brake system, a traction control system and a vehicle dynamics control system/electronic stability program, are possible by way of the hydraulic pumps and valves.

The hydraulic dual circuit vehicle brake system according to the disclosure is provided, in particular, for hydraulic pumps which do not deliver continuously, but rather, for example, in a pulsed manner, such as piston pumps. It can also be used, however, with different hydraulic pumps, such as gear pumps. In order to reduce pressure pulses and pressure peaks, the vehicle brake system according to the disclosure has a piston/cylinder unit which is connected to the pressure sides of the hydraulic pumps in the two brake circuits in such a way that the piston pump of one brake circuit communicates with one piston side, and the piston pump of the other brake circuit communicates with another piston side of a piston of the piston/cylinder unit. The piston of the piston/cylinder unit disconnects the two brake circuits hydraulically. A high pressure on the pressure side of the hydraulic pump of one brake circuit increases the pressure in the other brake circuit via the piston of the piston/cylinder unit, as long as the pressure of said other brake circuit is lower. At the same time, the pressure on the one brake circuit is lowered or increases to a lesser extent than without the piston/cylinder unit. The piston/cylinder unit is effective, in particular, in the case of hydraulic pumps which deliver discontinuously in opposite directions, that is to say in the case of hydraulic pumps, of which one is delivering while the other is not delivering.

In order to damp pressure changes, pressure oscillations and pressure jumps, the disclosure provides an elastically deformable displacement body on each piston side in the cylinder of the piston/cylinder unit.

All of the features which are disclosed in the description and the drawing can be implemented individually per se or in fundamentally any desired combination in embodiments of the disclosure. Embodiments of the disclosure which do not have all features of a claim, but rather merely one or more features of a claim, are fundamentally possible.

### BRIEF DESCRIPTION OF THE DRAWINGS

The disclosure will be described in greater detail in the following text using one embodiment which is shown in the drawing, in which:

FIG. 1 shows a hydraulic circuit diagram of a hydraulic dual circuit vehicle brake system according to the disclosure;

FIG. 2 shows an axial section of a piston/cylinder unit of the vehicle brake system from

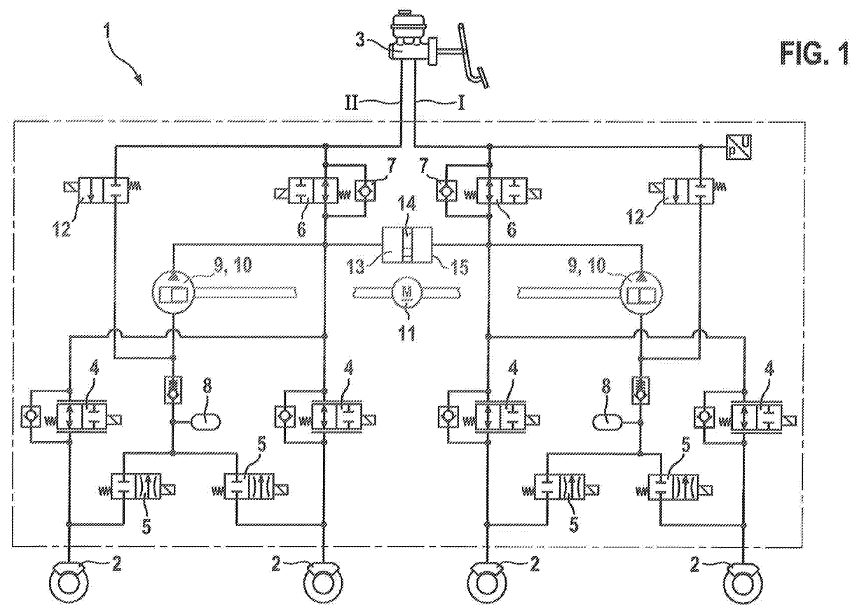

FIG. 1 with a balanced pressure on both sides of the piston; and

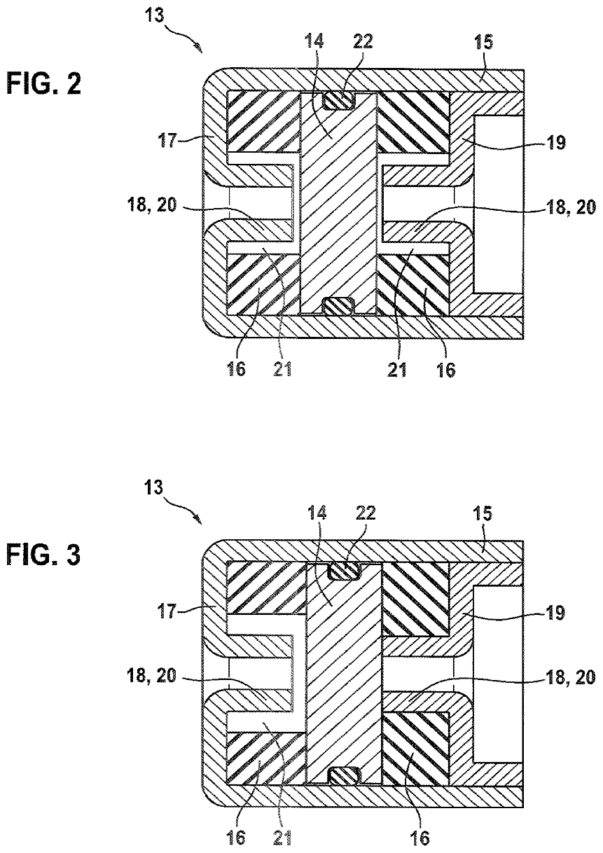

FIG. 3 shows the piston/cylinder unit from FIG. 2 with pressure loading on one piston side.

### DETAILED DESCRIPTION

The hydraulic dual circuit vehicle brake system 1 according to the disclosure which is shown in the drawing is provided for a motor car (not shown) with four vehicle wheels which have in each case one hydraulic wheel brake 2. The vehicle brake system 1 has two brake circuits I, II with in each case two hydraulic wheel brakes 2 which are connected to a dual circuit brake master cylinder 3. Each wheel brake 2 is assigned an inlet valve 4 and an outlet valve 5. The inlet valves 4 and the outlet valves 5 form wheel brake pressure control valve arrangements 4, 5 for the wheel-individual control of wheel brake pressures in the wheel brakes 2. In the exemplary embodiment, the inlet valves 4 are open 2/2-way solenoid valves in their currentless basic positions, and the outlet valves 5 are closed 2/2-way solenoid valves in their currentless basic positions.

The wheel brakes 2 are connected in two brake circuits I, II via in each case one separating valve 6 and their inlet valves 4 to the brake master cylinder 2. In the exemplary embodiment, the separating valves 6 are open 2/2-way solenoid valves in their currentless basic positions. Check valves 7 are hydraulically connected in parallel with the separating valves 6, through which check valves 7 flow can pass in the direction from the brake master cylinder 3 to the wheel brakes 2.

Each brake circuit I, II has a hydraulic accumulator 8 and a piston pump 9 as hydraulic pump 10 which can be driven by way of a common electric motor 11. The piston pumps 9 can also be considered to be pump elements. They are driven in opposite directions by means of an eccentric (not shown), that is to say they deliver in an alternating manner. By way of the air outlet valves 5, the wheel brakes 2 are connected to the hydraulic accumulators 8 and to suction sides of the hydraulic pumps 10. Pressure sides of the hydraulic pumps 10 are connected to the brake circuits I, II between the separating valve 6 and the inlet valves 4. Wheel brake pressures can be controlled individually in each wheel brake 2 by way of the inlet valves 4 and the outlet valves 5, which form the wheel brake pressure control valve arrangements 4, 5, and the hydraulic pumps 10, and slip control systems such as an anti-lock brake system, a traction control system and/or a vehicle dynamics control system/electronic stability program, for which the abbreviations ABS, ASR, FDR and ESP are customary, are possible in a manner known per se. An actuation of the vehicle brake system 1 independently of an actuation of the brake master cylinder 3 is also possible by way of the hydraulic pumps 10. In this case, wheel brake pressures in the wheel brakes 2 can also be controlled by way of the inlet valves 4 and the outlet valves 5. In order to improve a control accuracy, the inlet valves 4 in the embodiment of the disclosure which is shown and described are configured as proportional valves.

Moreover, the vehicle brake system 1 has an intake valve 12 in each brake circuit I, II, by way of which intake valves 12 the suction sides of the hydraulic pumps 10 can be connected to the brake master cylinder 2, in order for it to be possible for a brake pressure to be built up rapidly by way of the hydraulic pumps 10 in the case of a non-actuated brake master cylinder 2 and a pressureless vehicle brake system 1 in the case of cold and viscous brake fluid. In the exemplary embodiment, the intake valves 12 are closed 2/2-way solenoid valves in their currentless basic positions. A piston/cylinder unit 13 is connected to the pressure sides of the hydraulic pumps 10 which are configured as piston pumps 9, in such a way that each of the two hydraulic pumps 10 communicates with a piston side of a piston 14 of the piston/cylinder unit 13. FIG. 2 shows the piston/cylinder unit 13 in an enlarged axial section. The piston/cylinder unit 13 has a cylinder 15 which can also be configured as a bore in a hydraulic block (not shown) of the vehicle brake system 1. The piston 14 is arranged between two elastically deformable displacement bodies 16 in the cylinder 15, which displacement bodies 16 consist of an elastomer in the embodiment which is shown and described, and are circularly annular with a rectangular (square in the embodiment) ring cross section.

The cylinder 15 has a perforated disc-shaped end wall 17 at one end, from the center hole of which end wall 17 a tubular collar projects inward as a connector 18. At or in the other end, the cylinder 15 has a cover 19 likewise with a center hole, from which a tubular collar likewise projects inward as a connector 18. The piston 14 is situated between the two connectors 18, there being a spacing between the piston 14 and the connectors 18, with the result that the piston 14 can be displaced in the cylinder 15 axially to a limited extent. The connectors 18 which project inward into the cylinder 15 of the piston/cylinder unit 13 form piston travel limiting means 20 or a piston travel limiting means 20 which limit/limits an axial displacement travel of the piston 14 in the cylinder 15 in both directions.

The two annular displacement bodies 16 are arranged on the tubular connectors 18 of the piston/cylinder unit 13 which project inward into the cylinder 15 of the piston/cylinder unit 13; they enclose the tubular connectors 18 leaving an annular gap 21. An external diameter of the non-deformed (that is to say not arranged in the cylinder 15) displacement body 16 is somewhat larger than an internal diameter of the cylinder 15, with the result that the displacement bodies 16 are prestressed radially in the cylinder 15. In the axial direction, the non-deformed displacement bodies 16 are somewhat thicker than an axial spacing of the piston 14 from the end wall 17 of the cylinder 15 and an axial spacing of the piston 14 from the cover 19, with the result that the displacement bodies 16 are prestressed axially in the cylinder 15, that is to say are compressed axially. As a result, the displacement bodies 16 seal the piston 14 on the two piston sides in the cylinder 15. Moreover, they damp a movement of the piston 14 in the cylinder 15 and prevent a hard impact of the piston 14 against the connectors 18 which form the piston travel limiting means 20. When the piston 14 bears against one of the two piston travel limiting means 20, the displacement body 16 on this piston side fills a space in the cylinder 15 between the piston 14 and the end wall 17 or the cover 19. This can be seen in FIG. 3, where the piston 14 is displaced toward the cover 19 and bears against its piston travel limiting means 20.

The piston 14 has a circumferential groove in its circumference, in which groove a sealing ring 22 lies which seals the piston 14 in the cylinder 15, with the result that the two brake circuits I, II are disconnected hydraulically. By way of the above-described additional sealing means with the displacement bodies 16 on both sides of the piston 14, the hydraulic disconnection of the two brake circuits I, II is ensured even in the case of any leak of the sealing ring 22.

The pressure sides of the hydraulic pumps 10 communicate by way of the connectors 18 with the cylinder 15 of the piston/cylinder unit 13. If the two hydraulic pumps 10 which are piston pumps 9 in the embodiment which is shown and described and deliver in opposite directions are driven by way of the electric motor 11, one of the two piston pumps 9 delivers brake fluid during its work and delivery stroke into the respective brake circuit I, II, from which part flows into the cylinder 15 and displaces the piston 14 toward the piston travel limiting means 20 on the other piston side. As a result, the piston 14 displaces an identical quantity of brake fluid into the respective other brake circuit II, I. As a result, a brake pressure rise in the one brake circuit I, II is firstly slower and smaller, and secondly a brake pressure rise also takes place in the other brake circuit II, I, the piston pump 9 of which performs a suction or return stroke at this time and does not deliver any brake fluid. It is reversed during the next stroke of the two piston pumps 9.

In the case of a neutral center position of the piston 14 in the cylinder 15 of the piston/cylinder unit 13 in the case of a pressureless cylinder 15 or in the case of an identical pressure on both piston sides, a volume in the annular gap 21 between the annular displacement bodies 16 and the tubular connectors 18 which project inward into the cylinder 15 is approximately half as large as a swept volume of the piston pumps 9, that is to say approximately half as large as a brake fluid volume which is delivered during a piston stroke. As a result, during a work and displacement stroke of one of the two piston pumps 9, approximately half of the delivered brake fluid volume flows out of the piston pump 9 into the cylinder 15 of the piston/cylinder unit 13, and an equally large brake fluid volume flows on the other side out of the cylinder 15 into the respective other brake circuit II, I.

The piston/cylinder unit 13 brings about a more homogeneous delivery of brake fluid which is distributed to a work or displacement stroke and a suction or return stroke of the piston pumps 9. The brake fluid volume which is delivered during two piston strokes which follow one another of the piston pumps 9 is not reduced.

What is claimed is:

1. A hydraulic dual circuit vehicle brake system, comprising:
a dual circuit brake master cylinder;
two brake circuits connected to the dual circuit brake master cylinder, each brake circuit of the two brake circuits including:
at least one hydraulic wheel brake configured to be pressure loaded via the brake master cylinder;
a hydraulic pump including a suction side and a pressure side, the suction side connected to the at least one hydraulic wheel brake and the pressure side connected to the at least one hydraulic wheel brake and to the dual circuit brake master cylinder, the hydraulic pump configured to convey hydraulic pump brake fluid out of the at least one hydraulic wheel brake in a direction of the dual circuit brake master cylinder and/or back into the at least one hydraulic wheel brake; and
a plurality of valves configured to regulate wheel brake pressure; and
a piston/cylinder unit including a cylinder and a piston having a first piston side and a second piston side, the piston/cylinder unit connected to the pressure side of each hydraulic pump of the two brake circuits such that the first piston side of the piston is configured to communicate with the pressure side of the hydraulic pump of one brake circuit, and the second piston side of the piston is configured to communicate with the pressure side of the hydraulic pump of the other brake circuit, the piston configured to disconnect the two brake circuits hydraulically, the cylinder having a first elastically deformable displacement body on the first piston side and a second elastically deformable displacement body on the second piston side.

2. The hydraulic dual circuit vehicle brake system according to claim 1, wherein the first and second elastically deformable displacement bodies are annular.

3. The hydraulic dual circuit vehicle brake system according to claim 1, wherein the first and second elastically deformable displacement bodies are prestressed axially and/or radially.

4. The hydraulic vehicle brake system according to claim 1, wherein the hydraulic pumps are piston pumps.

5. The hydraulic vehicle brake system according to claim 4, wherein the piston pumps are configured to deliver in opposite directions.

6. The hydraulic dual circuit vehicle brake system according to claim 4, wherein, as a result of a displacement of the piston in the cylinder, variable volumes in the cylinder on both the first piston side and the second piston side are half as large as delivery volumes of the piston pumps during one piston stroke.

7. The hydraulic dual circuit vehicle brake system according to claim 1, wherein:
the piston/cylinder unit further includes a respective tubular connector to each brake circuit of the two brake circuits;
the respective tubular connectors protrude to an inside of the cylinder and limit a displacement of the piston in both directions; and
the first and second elastically deformable displacement bodies are arranged in an annular manner and on the respective tubular connectors.

8. The hydraulic dual circuit vehicle brake system according to claim 1, wherein:
the cylinder includes a first piston travel limiting member configured for a first displacement direction of the piston and a second piston travel limiting member configured for a second displacement direction of the piston;
the first elastically deformable displacement body takes up a first residual volume in the cylinder on the first piston side when the piston bears against the first piston travel limiting member; and
the second elastically deformable displacement body takes up a second residual volume in the cylinder on the second piston side when the piston bears against the second piston travel limiting member.
